(19) United States
(12) Patent Application Publication
(10) Pub. No.: US 2008/0105522 A1
(43) Pub. Date: May 8, 2008

(54) Electrical connector

(76) Inventor: Ted Ju, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/594,175

(22) Filed: Nov. 8, 2006

(51) Int. Cl. H01H 15/00

(52) U.S. Cl. 200/16 R

(57) ABSTRACT

An electrical connector includes an insulative housing, and a plurality of terminals arranged in the insulative housing. Each of the terminals has a first set and a second set of contacts. The first set of contacts is made of resilient materials, and the second set of contacts is made from red brass. In comparison with the conventional technology, various materials of the terminals are characterized in the present invention. One part of each terminal is made from red brass which has high conductivity, low flexibility and low cost, and the other part of each terminal is made from copper alloy, which has lower conductivity and higher flexibility than red brass. Therefore, the various materials assembled together in a single terminal allow rapid transmission between components, so as to broaden their application.

### BACKGROUND OF THE INVENTION

1. Field of the Invention

The present invention relates to an electrical connector, and in particular to an electrical connector adapted for various terminals made of different materials, in order to increase the speed of transmission between components, to which the electrical connector connects.

2. Background of the Invention

A conventional socket for switching power usually includes an insulative housing, a sliding member and a plurality of terminals. The insulative housing has a foundation and a lid, and the terminals include movable conducts and orientation conducts. The orientation conducts include a first orientation pin and a second orientation pin. The orientation conducts are secured to the foundation and the movable conducts are arranged to the sliding member. The sliding member can slide right and left relative to the insulative housing on a plane surface. This arrangement makes the movable conducts and a flexible-using pin flexibly contact either the first or the second orientation pin in order to connect with a power source and switch. However, these three kinds of conducts or pins are generally made from copper alloy, such as phosphor bronze (which is cheap, with good flexibility but poor conductivity of about 20% IACS), special copper (with reasonable cost and reasonable conductivity of about 40%-60% IACS), or beryllium copper (with good conductivity of over 80% IACS but very expensive). Moreover, the total conductivity of beryllium copper is inadequate for improving the electronic performance of the connector.

Hence, an improvement over the prior art is desired to overcome the disadvantages thereof.

### SUMMARY OF INVENTION

An objective according to the present invention is to provide an electrical connector, which could adequate to high speed of signal transmission between components due to the conductive nature of the terminals thereof.

To achieving this objective, the electrical connector according to the present invention includes an insulative housing, and a plurality of terminals arranged in the insulative housing. Each of the terminals has a first set and a second set of contacts. The first set of contacts is made of resilient materials, and the second set of contacts is made from red brass.

In comparison with the conventional technology, various materials for terminals are characterized in the present invention. One part of each terminal is made from red brass which has high conductivity, low flexibility and low cost, and the other part of each terminal is made from copper alloy, which has lower conductivity and higher flexibility than red brass. Therefore, the various materials assembled together in a single terminal increase the speed of transmission between the components, and broaden the application and make the electrical connector of present invention more useful.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, wherein:

FIG. 1 is a perspective view of an electrical connector according to the present invention;

FIG. 2 is a cross-sectional profile of the electrical connector according to the present invention;

FIG. 3 is an exploded view of FIG. 2;

FIG. 4 is an exploded view of part of the connector according to the present invention;

FIG. 5 is an exploded view of another part of the connector according to the present invention; and

FIG. 6 is an exploded view of another embodiment of the electrical connector according to the present invention.

### DETAILED DESCRIPTION OF THE EMBODIMENTS

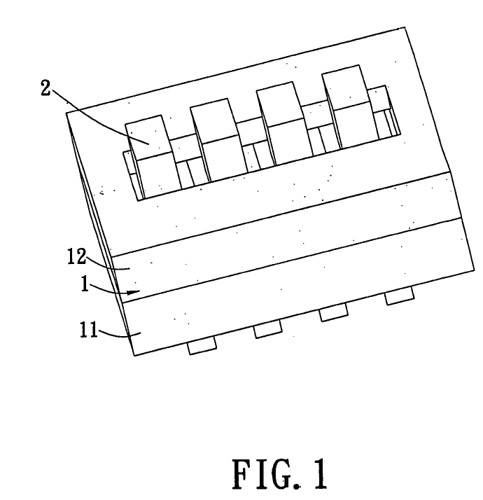

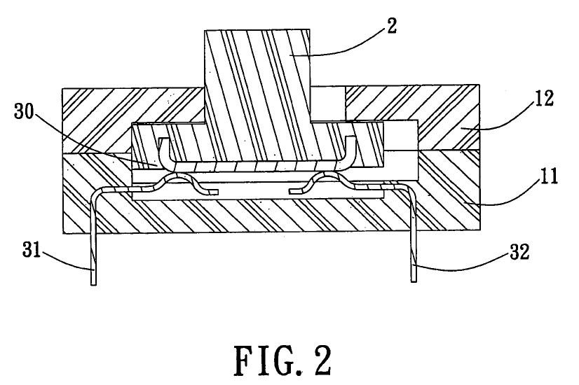

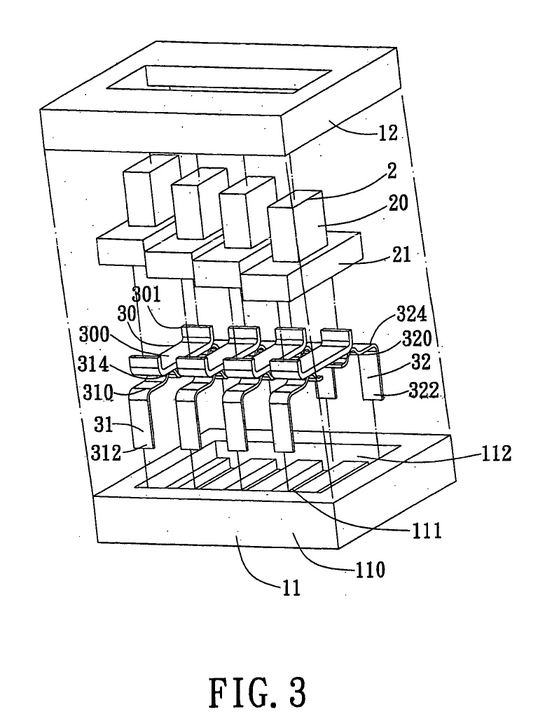

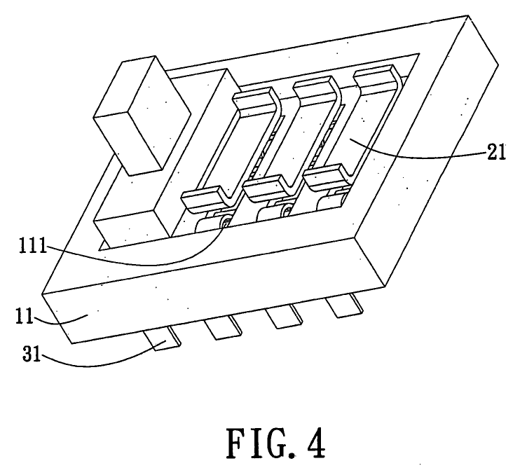

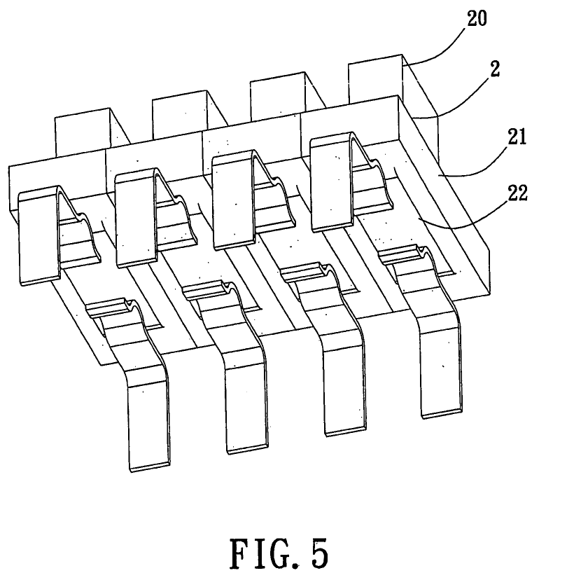

Referring to FIGS. 1 to 5, an electrical connector according to the present invention includes an insulative housing 1, a sliding member 2 and a plurality of terminals. The insulative housing 1 includes a foundation 11, a sliding member 2, and a lid 12 adapted to the foundation 11 for clamping with and restraining the sliding member 2. The sliding member 2 is relative to the foundation 11 or the lid 12 so that it could be moved rightwards and leftwards along a plane surface. Each of the terminals has a first set and a second set of contacts. The second set of contacts includes a movable conduct 30, and the first set of contacts includes two orientation conducts, which resiliently contacted with the movable conduct 30. Each orientation conduct includes a first orientation pin 31 and a second orientation pin 32. The orientation conducts are arranged in receiving slots different from the movable conducts 30. The movable conduct 30 is arranged in the sliding member 2, whereas the orientation conducts are arranged on the foundation 11. The first and second orientation pins 31, 32 are made of resilient materials, such as copper alloy in this embodiment, which has high tensile strength and flexibility. The movable conducts 30 are made from red brass, which has poor flexibility but with high conductivity, high plasticity, high ductibility and low tensile strength. The first and second orientation pins 31, 32 are resilient and movably contacted with the movable conducts 30.

The electrical connector of the present invention includes a plurality of units. In this embodiment, there are four units in the electrical connector. Each unit has the sliding member 2, the movable conduct 30 arranged in the sliding member 2, and the first and second orientation pins 31, 32 are contacted with lateral sides of the movable conduct 30 and arranged in the foundation 11.

The foundation 11 has a bed 110, a plurality of first receiving slots 111 formed on the bed 110, and a second receiving slot 112 for orientating and restraining the sliding member 2. The first receiving slots 111 contain the first and second orientation pins 31, 32. The sliding member 2 includes an operation portion 20, a ground 21 and a third receiving slot 22 formed on the ground 21 for containing the movable conducts 30.

The first orientation pin 31 is L shaped, it includes a holding member secured to the insulative housing 1, a first conduction portion 312 for electrically connecting with the electronic member, such as a printed circuit board (not shown in the figures), and a first touching portion 314 downwardly folded and extending from an end of the first conduction portion 312. The holding member includes a first holding portion 310 fixed in the corresponding first receiving slot 111. The first touching portion 314 is resilient and electrically connects with the movable conducts 30 of the second set of contacts. The structure of the second orientation pin 32 is similar to that of the first orientation pin 31, and the first and second orientation pins 31, 32 are arranged correspondingly. The second orientation pin 32 also includes a second holding portion 320, a second conduction portion 322, and a second touching portion 324 downwardly folded and extending from one end of the second conduction portion 322. The second touching portion 324 is resilient and electrically connects with the movable conducts 30 of the second set of contacts. The touching portions belong to the orientation conducts of the first set of contacts (the first touching portion 314 and the second touching portion 324) and can conduct to the movable conducts 30 of the second set of contacts and have a resilient movement in a vertical direction.

The movable conduct 30 of the second set of contacts is U-shaped, and is different from the L-shaped orientation conducts. The movable conduct 30 includes a fixing member secured to the insulative housing 1 and a base 300 conducting to the touching portions 314 and 324 of the first set of contacts. The base 300 and the touching portions 314 and 324 of the first set of contacts slide with each other. The fixing member includes two fixing portions 301 opposite to each other and secured to the third receiving slot 22 of the sliding member 2. The movable conducts 30 are relative to the orientation conducts and move rightwards and leftwards horizontally. During the movement of the movable conducts 30, the base 300 can flexibly contact with the touching portions 314 and 324, so that the base 300 and the selected one of the touching portions 314 and 324 can be connected to the power source or switch.

When the operation portion 20 is operated, the sliding member 2 driven by the operation portion 20 pushes the movable conducts 30 leftward, so as to resiliently connect to the first touching portion 314 of the first orientation pin 31 for conduction. Alternatively, the sliding member 2 can be moved by the operation portion 20 for removing the movable conducts 30 from the first orientation pin 31, so as to resiliently connect the movable conducts 30 with the second touching portion 324 of the second orientation pin 32. Similar to the operation processes, the sliding members 2 of the four units can be operated at the same time for various functions.

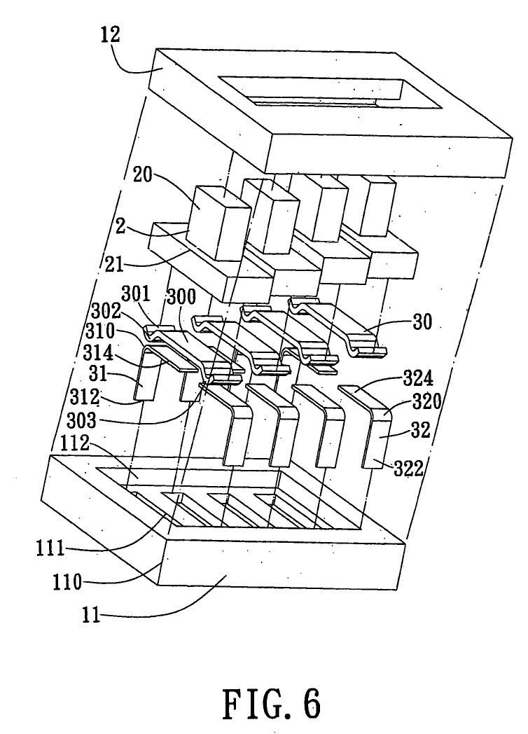

Referring to FIG. 6, another embodiment according to the present invention is illustrated. The first set of the contacts includes a conduct, which is a movable conduct 30 made from resilient copper alloy. The second set of contacts includes two conducts, which are orientation conducts made from red brass with high conductivity and low flexibility. The orientation conducts include a first orientation pin 31 and a second orientation pin 32. The movable conduct 30 includes a base 300, two fixing portions 301 extending from opposite ends of the base 300 upwardly and received in the third slots 22 of the sliding member 2, a first flexible touching portion 302, and a second flexible touching portion 303 curved and adjacent to the orientation portions respectively. The first orientation pin 31 of the second set of contacts includes a holding portion 310 secured in the first receiving slot 111 of the foundation 11, a first conductive portion 312 for electrically connecting with the electronic member, such as printed circuit board (not shown in the figures), and a first touching portion 314 downwardly folded and extending from one end of the first conduction portion 312. The structure of the second orientation pin 32 is similar to that of the first orientation pin 31, and the first and second orientation pins 31, 32 are arranged correspondingly. The second orientation pin 32 also includes a second holding portion 320, a second conductive portion 322, and a second touching portion 324.

The movable conducts 30 can be relative to the orientation conducts and move rightwards and leftwards horizontally. The movable conducts 30 include a first flexible touching portion 302 and a second flexible touching portion 303. The first and second flexible touching portions 302, 303 have a resilient upward movement in a vertical direction. When the sliding member 2 moves leftward, the sliding member 2 carries the first flexible touching portion 302 of the movable conduct 30 and the first touching portion 314 of the first orientation conduct 31 for electrical connection. When the sliding member 2 moves rightward, the sliding member 2 carries the first flexible touching portion 302 of the movable conducts 30 off the first orientation pin 31, so as to switch the second flexible touching portion 303 electrically connecting to the second touching portion 324 of the second orientation pin 32.

The goals of the second embodiment are the same as those of the first embodiment and are therefore not described further in the detailed description of the second embodiment.

In comparison with the conventional technology, various materials of terminals are characterized in the present invention. One part of each terminal is made of red brass with high conductivity, low flexibility and a low cost. The other part of each terminal is made of copper alloy, which has lower conductivity and higher flexibility than red brass. Therefore, the various materials assembled together in a single terminal allow rapid transmission between components, so as to broaden their application.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An electrical connector comprising:
an insulative housing; and
a plurality of terminals arranged in the insulative housing; wherein each of the terminals has a first set and a second set of contacts fabricated of different materials, the second set of contacts horizontally moves to contact to the first set of contacts at the same moment, the first set of contacts having a vertical deformation for upwardly abutting against the second set of contacts; wherein the first set of contacts is made of resilient materials, and the second set of contacts is made from red brass.

2. The electrical connector as claimed in claim 1, wherein the resilient materials include copper alloy.

3. The electrical connector as claimed in claim 1, wherein the first set of contacts includes two orientation conducts, and each of the orientation conducts has a holding member secured to the insulative housing and a touching portion conducted to the second set of contacts.

4. The electrical connector as claimed in claim 3, wherein the touching portion has a resilient movement along a vertical direction.

5. The electrical connector as claimed in claim 1, wherein the second set of contacts includes a movable conduct having a fixing member secured to the insulative housing and a base, wherein the base and the first set of contacts slide to each other.

6. The electrical connector as claimed in claim 3, wherein each of the orientation conducts of the first set of contacts has a resilient movement along a vertical direction.

7. The electrical connector as claimed in claim 5, wherein the movable conduct of the second set of contacts has a displacement sliding movement along a horizontal direction.

8. The electrical connector as claimed in claim 1, wherein the first set of contacts include a movable conduct having a fixing member secured to the insulative housing and a base; wherein the base and the second set of contacts slide to each other, and the base includes a flexible touching portion.

9. The electrical connector as claimed in claim 8, wherein the flexible touching portion has a resilient movement along a vertical direction.

10. The electrical connector as claimed in claim 1, wherein the second set of the contacts includes at least two orientation conducts, each orientation conduct has a holding portion secured in the insulative housing and a touching portion conducted to the first set of contacts.

11. The electrical connector as claimed in claim 8, wherein the movable conduct has a resilient movement along a vertical direction and a displacement sliding movement along a horizontal direction in a simultaneous manner.

12. The electrical connector as claimed in claim 1, wherein the insulative housing includes a foundation, a sliding member, and a lid adapted to the foundation for clamping with and retraining the sliding member; wherein the foundation has a bed, a plurality of first receiving slots formed on the bed and containing the terminals correspondingly, and a second receiving slot orientating and restraining the sliding member.

13. The electrical connector as claimed in claim 12, wherein the sliding member includes an operation portion, a ground, and a third receiving slot formed on the ground for containing the terminals; wherein the sliding member is relative to the foundation and moves rightwards and leftwards on a plane surface.

14. An electrical connector comprising:
an insulative housing; and
a plurality of terminals arranged in the insulative housing, wherein each of the terminals has:
a first set of contacts made of resilient materials, wherein the first set of contacts has a touching portion;
a second set of contacts made from red brass, wherein the second set of contacts is formed as a rigid body; and
the first set and second set of contacts fabricated of different materials in electrical contact with each other;
wherein a gap is formed vertically between the touching portion and the insulative housing and the touching portion moves vertically when the second set of contacts moves horizontally to force a stress on the first set of contacts.
